(19) United States
(12) Patent Application Publication
(10) Pub. No.: US 2015/0046462 A1
(43) Pub. Date: Feb. 12, 2015

(54) IDENTIFYING ACTIONS IN DOCUMENTS USING OPTIONS IN MENUS

(71) Applicant: Microsoft Corporation, Redmond, WA (US)

(72) Inventors: Jian-Tao Sun, Beijing (CN); Xiaochuan Ni, Beijing (CN); Zheng Chen, Beijing (CN)

(21) Appl. No.: 14/522,478

(22) Filed: Oct. 23, 2014

Related U.S. Application Data
(63) Continuation of application No. 12/964,997, filed on Dec. 10, 2010, now abandoned.

(51) Int. Cl. G06F 17/30

(52) U.S. Cl. CPC G06F 17/30011; G06F 17/30598
USPC 707/740

(57) ABSTRACT

Documents such as web pages may be regarded as offering various actions; e.g., a website for a movie theater may offer options for viewing movie listings and purchasing tickets. A user may wish to view the set of actions available for a particular document, and/or the performance of an action. However, it may be difficult to identify available actions with acceptable accuracy in an automated manner, and the set of documents (such as the entire worldwide web) may be too voluminous for human identification. In order to identify available actions, the document may be searched for menus containing options, and identifying the actions associated with each option according to an option score. Additionally, documents may be grouped into document categories (e.g., websites for movie theaters and websites for musicians) to facilitate the association options in similar documents with similar sets of actions that are often provided for such documents.

### CROSS-REFERENCE TO RELATED APPLICATIONS

The present application is a continuation of and claims priority to U.S. patent application Ser. No. 12/964,997, filed Dec. 10, 2010 and also entitled “Identifying Actions in Documents Using Options in Menus,” the entirety of which is incorporated by reference as if fully rewritten herein.

### BACKGROUND

Within the field of computing, many scenarios involve a set of documents associated with one or more actions. As a first example, a web page for a particular topic may be associated with various actions related to the topic. In a first such example, a website or a restaurant may feature actions such as “view menu,” “make a reservation,” and “show directions to restaurant.” In a second such example, a website for a movie theater may feature actions such as “view movie listings”, “buy tickets”, and “view a map of the theater.” In a third such example, a website for a musician may feature actions such as “view upcoming shows,” “hear samples,” and “contact the musician.” As a second example, a human-readable document may include hyperlinks associated with various actions, such as “jump to index,” “insert annotation,” and “view footnote.”

Users who interact with various documents may wish to utilize the actions associated with a document. Moreover, the user may access the document in a variety of ways, such as on a full-featured application running on a desktop computer, a limited-featured application running on a portable device such as a mobile phone, and a voice-only application interfacing with the user in a voice communication session.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Despite the different types of devices that a user may operate to access a document, and the varied capabilities of such devices, a user may wish to identify and access the same set of actions associated with the document. Moreover, the user may expect consistent behavior among the interaction with the actions of the documents, regardless of the device and its capabilities. Therefore, it may be desirable to identify the actions associated with the document and to allow the user to select among these actions. However, the number of documents that the user may access (e.g., the set of web pages comprising the internet) may be too voluminous to permit a human-automated identification of actions for respective documents, and it may be difficult to identify the actions in an automated manner.

It may be appreciated that authors of documents (such as web pages) often present the actions associated with the document in a menu. Many menus may be available on the page that may present many types of information, but some menus may be oriented toward presenting actions associated with the document. Moreover, it may be appreciated that documents may be categorized into one or more document categories (e.g., web pages representing restaurants, web pages representing movie theaters, and web pages representing musicians), and similar actions may be presented within the documents of a particular document category (e.g., web pages for restaurants are likely to include actions such as “view menu” and “make reservations,” while web pages for movie theaters are likely to include action such as “view listings” and “buy tickets”).

Based on these observations, techniques may be devised to identify the actions associated with one or more documents. In accordance with these techniques, the menus of a document may be automatically evaluated to identify various options exposed by the menu. These options may be automatically assigned an option score, based on lexical techniques (e.g., options comprising dictionary-defined verbs or nouns may be more likely to comprise actions than options such as proper nouns). The option scores of the options of a particular menu may be tabulated into a menu score indicating the likelihood that the menu presents a set of actions, and the menu scores of the menus may be tabulated into a document score indicating the likelihood that the document offers a set of actions. These automated calculations may be performed iteratively, e.g., until the option scores converge. Additionally, documents may be categorized into document categories, wherein the documents in a particular document category are more likely to present similar actions. The options may therefore be clustered, based on the frequency of the option appearing in the menus and documents within a particular document category. Options having high option scores may be associated with actions, which may be identified as available for the documents featuring a menu having the option. For example, when a user requests to make a reservation on a restaurant, the “make reservation” action associated with a “Reserve” option in a menu of a web page categorized as a restaurant website may be identified, and the action may be presented to the user (e.g., by presenting the web page associated with the specified action). In this manner, the actions associated with various documents may be automatically identified for various types of presentation to users.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a set of users accessing a set of documents associated with various actions.

FIG. 2 is an illustration of an exemplary scenario featuring a set of documents having a set of menus respectively having a set of options.

FIG. 3 is an illustration of an exemplary scenario featuring an association of options of menus of documents with actions in accordance with the techniques presented herein.

FIG. 4 is an illustration of another exemplary scenario featuring an association of options of menus of documents with actions in accordance with the techniques presented herein.

FIG. 5 is a flow chart illustrating an exemplary method of identifying actions available for various documents.

FIG. 6 is a component block diagram illustrating an exemplary system for identifying actions available for various documents.

FIG. 7 is an illustration of an exemplary computer-readable medium comprising processor-executable instructions configured to embody one or more of the provisions set forth herein.

FIG. 8 is an illustration of an exemplary scenario featuring a scoring of options, menus, and documents.

FIG. 9 is an illustration of an exemplary scenario featuring a scoring of options, menus, and documents using corresponding formulae.

FIG. 10 an exemplary scenario featuring an iterative merging of options into actions.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve the presentation of a document, such as a web page of a website, a Portable Document Format (PDF) object, or Rich Text Format (RTF) object. Such documents may contain many objects, such as text formatting markers, embedded images, hyperlinks, and layout elements such as tables and frames. These documents may also relate to various topics. For example, a web page may present information about a restaurant, a theater, or a musician, and a Portable Document Format (PDF) object may present a fillable form such as a tax reporting document, an advertisement for a service, or a user manual or a product. The documents may also be accessed by a user through many devices, such as desktop or laptop computers and the visual display of a smartphones. In some such scenarios, a user may access the document through a non-visual mechanism; e.g., a user of a phone may request a computer to read a document to a user by applying a text-to-speech application, while a visually impaired user may access a document using a text-to-Braille haptic device. Additionally, with respect to a document and the topic(s) related therein, a user may wish to take various actions.

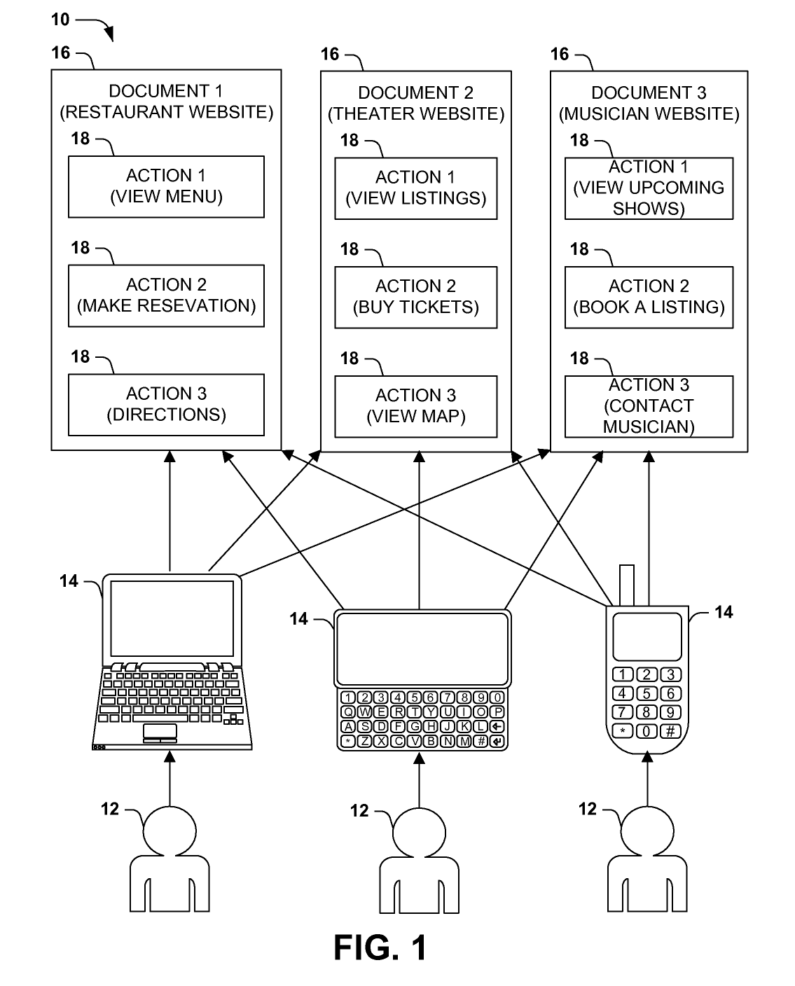

FIG. 1 presents an exemplary scenario 10 featuring a set of users 12 of various devices 14, including a notebook computer, a visual display of a portable device, and a mobile phone. In this exemplary scenario 10, these users 12 may operate these devices 14 to access various documents 16 (depicted in this exemplary scenario 10 as web pages) relating to various topics. For example, a first document 16 relates to a restaurant; a second document 16 relates to a movie theater; and a third document 16 relates to a musician. These users 12 may access these documents 16 to retrieve information about the related topics, such as viewing images of the restaurant and available entrées, reading about the seating and screens available at the theater, and listening to samples of music performed by the musician. However, the interactions of the users 12 with the documents 16 may also involve specific actions that the users 12 wish to perform with respect to the topics related therein. As a first example, a user 12 reading a document 16 relating to a restaurant may wish to perform actions 18 such as viewing a menu of the restaurant, making a reservation at the restaurant, and receiving directions from the current location of the user 12 to the restaurant. As a second example, a user 12 reading a document 16 relating to a movie theater may wish to perform actions 18 such as viewing a listing of movies showing at the theater, buying tickets to a movie, and viewing a map of the movie theater. As a third example, a user 12 reading a document 16 relating to a musician may wish to perform actions 18 such as viewing upcoming shows where the musician is playing, booking the musician for a show, or contacting the musician with a question or comment. In some such scenarios, a similar set of actions 18 may be frequently requested by users 12 regarding many documents of a particular document type, such as those documents relating to a particular topic. For example, users 12 visiting websites for different restaurants may often wish to perform actions 18 such as viewing a menu or making reservations, and users 12 visiting websites for movie theaters may often wish to perform actions 18 such as viewing movie listings and purchasing tickets.

The identification of actions 18 available in document 16 to a user 12 may be useful in many ways. As one example, a user 12 may wish to interact with the document 16 using many types of devices 14 having various types of capabilities, including a desktop or notebook computer having a large display and a robust set of input devices (such as a keyboard, a mouse or touchpad, and a touch-sensitive screen), a smartphone having a smaller display and a more limited input device (such as a hardware or software keyboard), and a telephone, cellphone, or voice-over-IP client having only a voice input and only a voice output. Nevertheless, the user 12 may wish to interact with the document 16 in a similar manner regardless of the current device 14, and so may wish to be presented with a consistent set of actions 18. For example, regardless of the characteristics of the device 14 being used whereby a user 12 visits a website for a movie theater, the user 12 may wish to perform actions such as examining movie listings, buying tickets, and receiving directions to the movie theater. Accordingly, it may be advantageous to permit the device 14 to identify the available actions 18 for a particular document 16, to present the available actions 18 to the user 12, and to execute an action 18 requested by the user 12. For example, a notebook computer, a smartphone device, and an audio-only cellphone may each present the same set of actions 18 to the user 12 for a website representing a movie theater, and when the user 12 requests to be presented with the current set of movie listings at a movie theater, the notebook computer may render the corresponding web page for the user 12; the smartphone device may present a simplified rendering of the same web page, or a table indicating the movies; and an audio-only cellphone may utilize a text-to-speech engine to speak the movie listings to the user 12.

These and other uses may be achieved based on an identification of actions 18 presented in a document 16. However, the identification of actions 18 associated with a particular document 16 may be difficult. As a first example, it may be feasible to create an information system whereby an author of a document 16 may specify one or more actions 18 associated with a document 16, but this technique involves the active cooperation of the author, and which may be unavailable for previously authored documents (such as the web pages currently comprising the worldwide web). As a second example, users 12 may identify actions 18 associated with a document 16, e.g., in a “crowdsourced” scenario where visitors to a website provide information on the actions 18 associated with different web pages, or where individual are paid to identify such actions 18. However, solutions that significantly involve human intervention may be inefficient, inconsistent, inadequate for identifying actions 18 in a large and rapidly changing set of documents 16 (such as the worldwide web), and/or may be expensive. As a third example, automated lexical analyzers may be applied to analyze various documents 16, such as a natural-language parser that endeavors to extract actions 18 based on human-readable text in the document 16. However, general-purpose lexical analyzers may be inefficient and/or inaccurate, since different authors of a document 16 may specify a particular action 18 using many different types of natural-language options.

As an alternative to these and other techniques for identifying the actions 18 associated with various documents 16, presented herein are techniques for identifying and using actions 18 associated with a document 16, such as the actions 18 that are available to visitors of a web page of a website. According to the techniques presented herein, it may be appreciated that authors of various documents 16 often expose such actions 18 to a user 12 in a menu, such as a horizontal or vertical navigation bar embedded in a web page of a website, a menu bar presented in a media rendering application for a rendered document 16, or a table of contents of a book. An automated technique (such as a software application) may endeavor to identify the menus associated with a document 16, and to identify the actions 18 available with respect to a document 16 based on the options provided in the menu.

However, it may be difficult to identify actions 18 associated with the options of a menu in a document 16. For example, it may be incorrect to presume that any option of any menu is associated with an action 18 available for the document 16. For example, a web page may present a first menu comprising a set of actions (e.g., “view movie listings,” “buy tickets,” and “view map of movie theater”), but may also present a second menu with options that do not necessarily correspond to actions 18 associated with the movie theater, e.g., links to other web pages that may be of interest to visitors of the website, or navigation controls such as Home, Back, and Search that might facilitate browser-based navigation of the website but that may not represent particular actions with respect to the website.

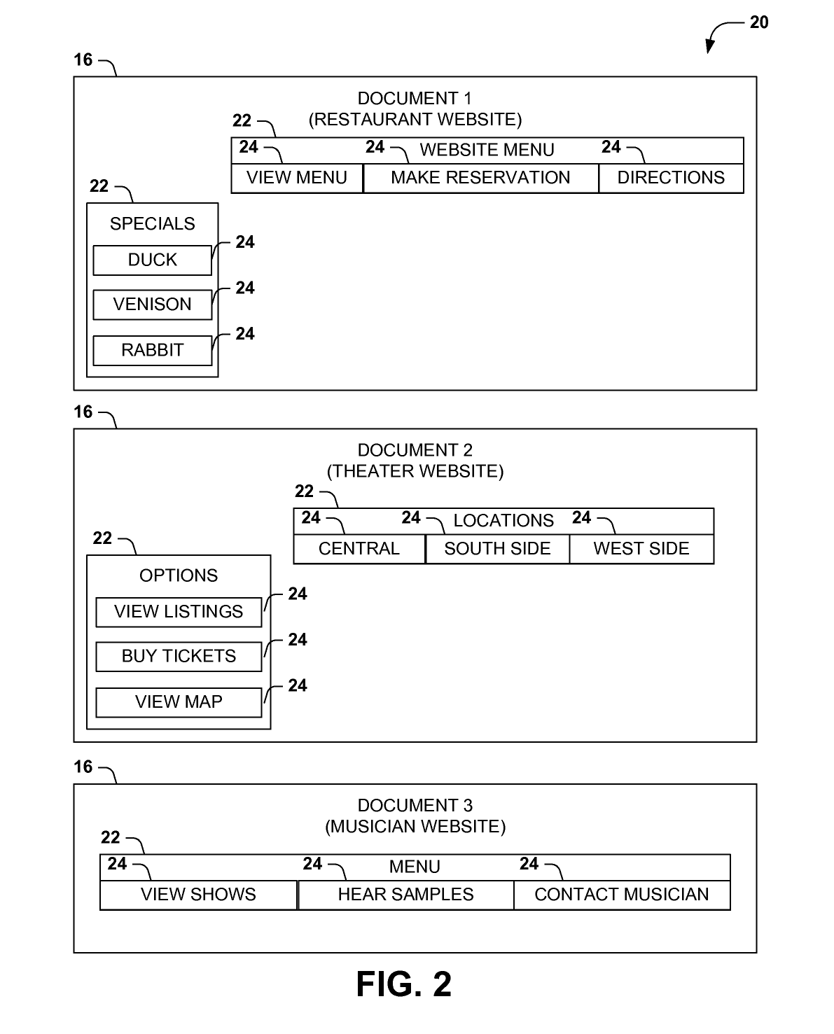

FIG. 2 presents some examples 20 of as websites for various topics, such as a first document 16 comprising a website for a restaurant, a second document 16 comprising a website for a movie theater, and a third document 16 comprising a website for a musician. Each of these documents 16 comprises one or more menus 22, where each menu 22 comprises a set of options 24. However, an automated technique may err by selecting every option 24 of every menu 22 as an action 18 associated with the document 16. As a first example, the first document 16 comprising the restaurant website features two menus 22, including a first menu 22 that is horizontally positioned near the top of the web page and that presents different options 24 associated with various web pages of the website, and a second menu 22 that is vertically positioned near the left side of the web page and that presents different special entrées offered by the restaurant. It may be appreciated that the options 24 of the first menu 22 may be associated with actions 18 involving the restaurant represented by the document 16, including viewing the menu, making a reservation, and viewing directions to the restaurant, but that the options 24 of the second menu 22 are not associated with actions 18. Conversely, in the second document 16 comprising a website for a chain of movie theaters, the options 24 of the first menu 22 positioned horizontally near the top of the website are associated with different locations where the movie theaters are located, and do not related to actions 18, but that the options 24 of the second menu 22 positioned vertically near the left side of the website are associated with actions 18 relevant to the movie theater.

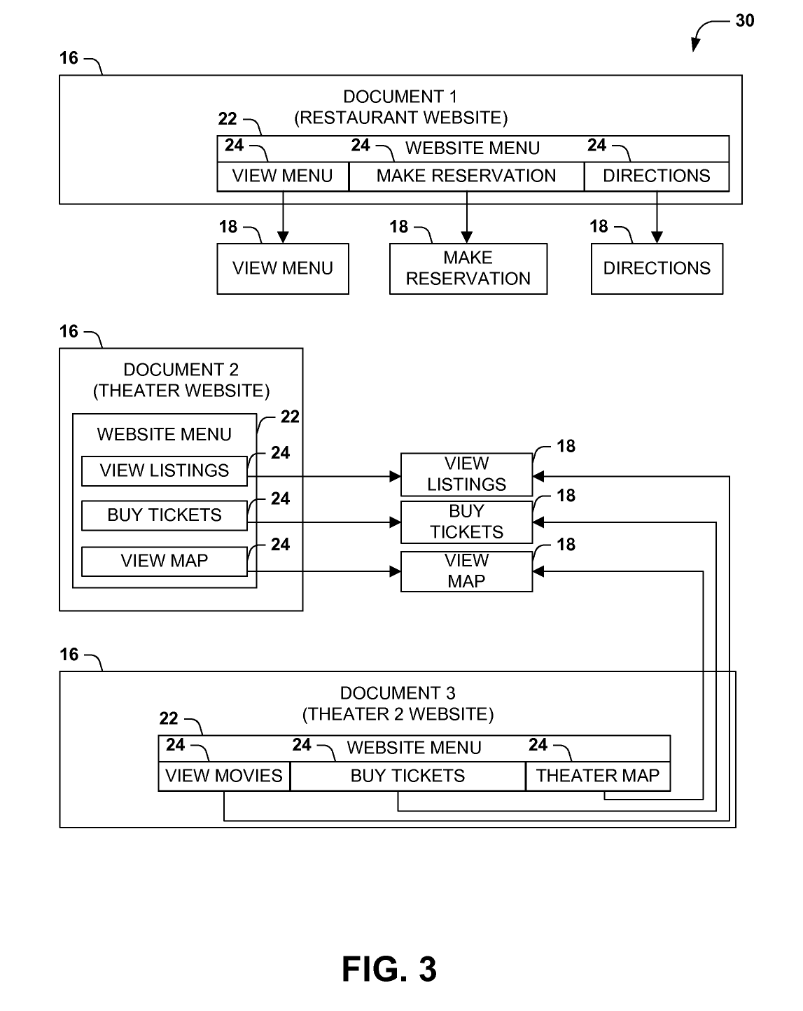

FIG. 3 depicts an exemplary scenario 30 featuring an identification of actions 18 associated with a document 16 using the options 24 of one or more menus 22 presented therein. In this exemplary scenario 30, a first document 16 comprising a website for a restaurant may include a menu 22 having various options 24. An application of these techniques may identify that the document 16 includes a menu 22, and, by evaluating the options 24 of the menu 22, may identify three actions 18 that are applicable to the document 16: viewing a menu, making a reservation, and presenting directions. Similarly, for a second document 16 comprising a website for a movie theater, an automated evaluation of the document 16 may identify the inclusion of a menu 22 including options 24 that may be associated with actions 18 for the document 16, such as viewing movie listings, buying tickets, and viewing a map of the movie theater. A similar set of options 24 may also be identified in a menu 22 for a third document 16 (even though the menu 22 is presented differently than the menu 22 in the second document 16, both in terms of position and layout and in terms of the words selected to describe the options 24). These options 24 of the third document 16 may be similarly associated with corresponding actions 18 that may be taken with respect to the third document 16.

In accordance with the techniques presented herein, an automated technique (such as a software process) may, after identifying the options available in the menus of a document 16, endeavor to identify which options correspond to actions 18 associated with the document 16. For example, the automated technique may attempt an automated classification of documents 16 according to document types, such as web pages associated with restaurants, web pages associated with movie theaters, web pages associated with musicians. It may be presumed that documents 16 belonging to a document category are more likely to have a similar set of actions 18. For example, in the exemplary scenario 30 of FIG. 3, it may be observed that the second document 16 and the third document 16 are associated with a similar set of actions 18 because both documents 16 belong to the same document category of websites describing movie theaters. Accordingly, a document 16 may be identified as belonging to a particular document category if the document 16 has a similar set of options as other documents 16 of the document category. Additionally, for a document 16 of a particular document category, the options that are identified in the document 16 may be identified as actions 18 if such options often appear in documents 16 of the document category. Conversely, an action 18 may be identified as characteristic of documents 16 of a particular document category if it frequently appears as an option in documents 16 of the document category. In accordance with the techniques presented herein, these observations may be used to choose actions 18 associated with particular options, based on the actions 18 that are often available within documents 16 of the document category to which the document 16 belongs. Moreover, in some embodiments, an iterative technique may be utilized to classify documents 16 into document categories based on similar sets of actions 18 identified therewith, and to identify actions 18 as associated with a particular document 18 based on the actions 18 that are characteristic of the documents 16 of the document category. By applying several incremental iterations of these processes, the embodiment may cluster similar documents 16 into document categories, and may identify common actions 18 among the documents 16 of the document category.

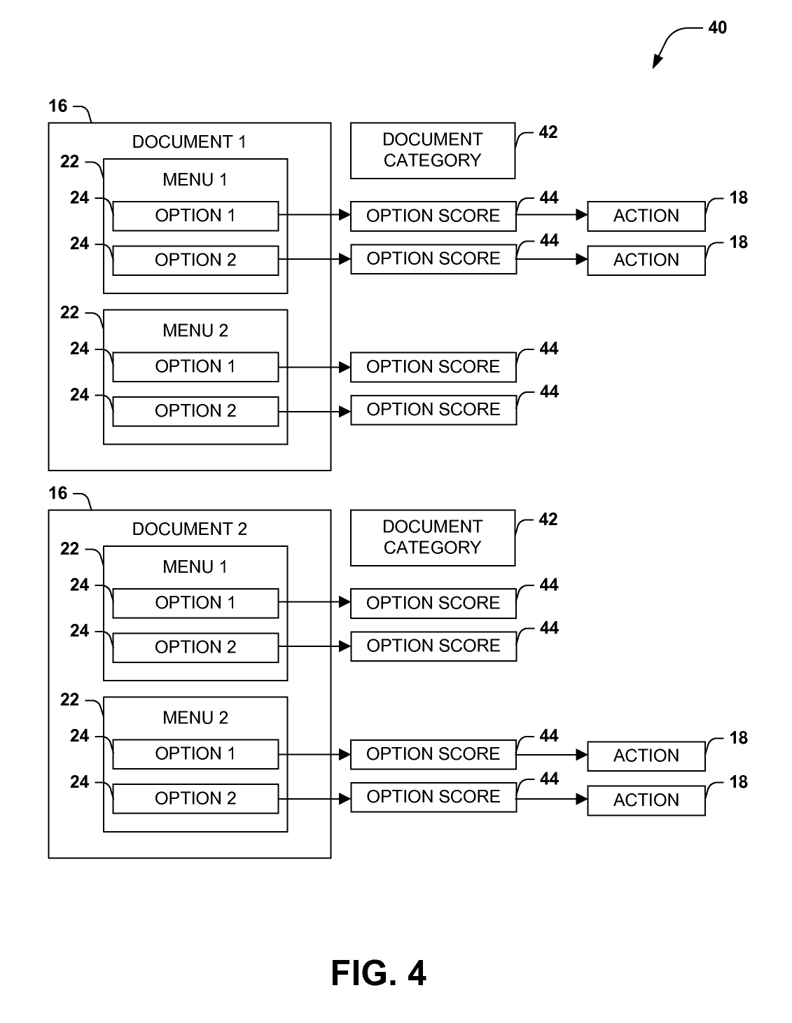

FIG. 4 presents an illustration of an exemplary scenario 40 wherein the actions 18 associated with various documents 16 may be identified based on these observations. In this exemplary scenario 40, two documents 16 are evaluated to identify actions 18 associated therewith. Each document 16 comprises two menus 22, and each menu 22 comprises two options 24. In accordance with the techniques presented herein, each document 16 may be evaluated to identify a document category 42 to which the document belongs 16, e.g., a particular topic that the document 42 may represent or describe, and/or a particular type or style of document 42, such as a biography of an individual, a blueprint of a location, a database for an information set, or a human-readable reference manual. For various options 24 of the respective menus 22 of the respective documents 16, an option score 44 may be calculated, indicating the likelihood that the option 24 represents an action 18 with respect to the document 16. This option score 44 may be calculated, e.g., based on similarity with actions 18 that are often presented for the documents 16 of the document category 42. The options 24 having high option scores 22 for a particular document 16 may then be selected as actions 18 that may be available for the documents 16, and may be presented to a user 12. When the user 12 selects a particular action 18 for a particular document 16, the corresponding option 24 associated with the action 18 for the document 16 may be invoked, e.g., by presenting to the user 12 the content of a web page hyperlinked by an option 24 in a menu 22 of a web page.

Additional variations may also be applied within the exemplary scenario 40 of FIG. 4. As a first example, menu scores may be computed and assigned to the menus 22 of a document 16, based on the option scores 44 of the options 24 within the menu 22, to indicate the likelihood that the menu 22 is designed to present a set of options 24 associated with the document 16 (or whether the menu 22 presents information other than actions, such as links to other websites or actions associated with navigation within the website). For a menu 22 having a high menu score, the option scores 44 of the options 24 of the menu 22 may be increased, while the option scores 44 of the options 24 of a menu 22 having a low menu score may be decreased. As a second example, document scores may be assigned to various documents 16, e.g., to indicate the likelihood that a document 16 belongs to a particular document category 42, based on a similarity of actions 18 identified for the document 16 with the actions 18 identified for other documents 16 within the document category 42. This determination may promote the clustering of documents 16 into document categories 42. Moreover, these calculations may be cyclic and incrementally iterative as a feedback loop. For example, if the options 24 in a menu 22 of a document 16 have high option scores 44, particularly for a particular document category 42, the document score of the document 16 may be increased; and if the document 16 has a high document score for a particular document category 42, the option scores 44 of the options 24 of the menu 22 of the document 16 that are similar to options 24 of other documents 16 within the document category 42 may be increased.

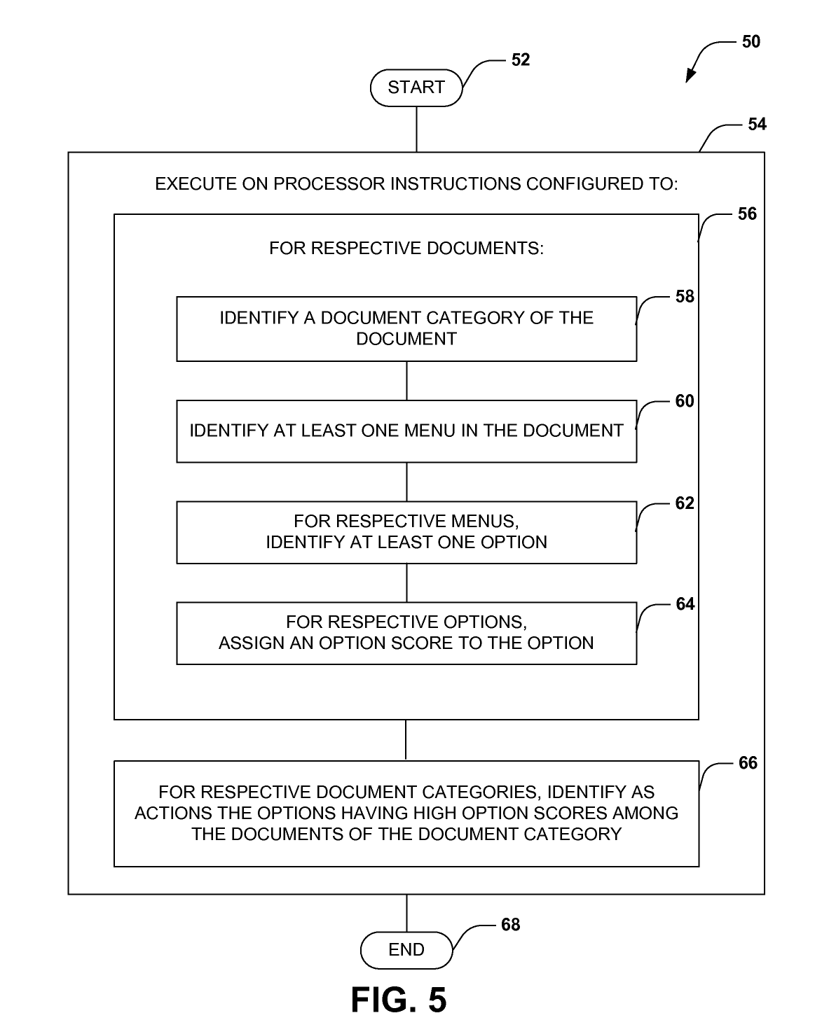

FIG. 5 presents a first embodiment of these techniques, illustrated as an exemplary method 50 of identifying actions 18 available for at least one document 16. The exemplary method 50 may, e.g., comprise instructions configured to perform the techniques presented herein, where such instructions may be stored in a memory of a device (such as system memory, a hard disk drive, a solid-state storage device, or an optical or magnetic disc) and performed on a processor of the device. The exemplary method 50 begins at 52 and involves executing on the processor instructions configured to implement the techniques presented herein. In particular, the instructions may be configured to, for respective 56 documents 16, identify 58 a document category 58 of the document 16; identify 60 at least one menu 22 in the document 16; and for respective menus 22, identify 62 at least one option 24. The instructions may then be configured to, for respective options 24 of the respective menus 22 of the document 16, assign 64 an option score 44 to the option 24. The instructions may also be configured to, for respective document categories 42, identify 66 as actions 18 the options 24 having high option scores 44 among the documents 16 of the document category 42. Having selected actions 18 for the document 16 based on the high-scoring options 24 of the menus 22 of the document 16, the exemplary method 50 ends at 68.

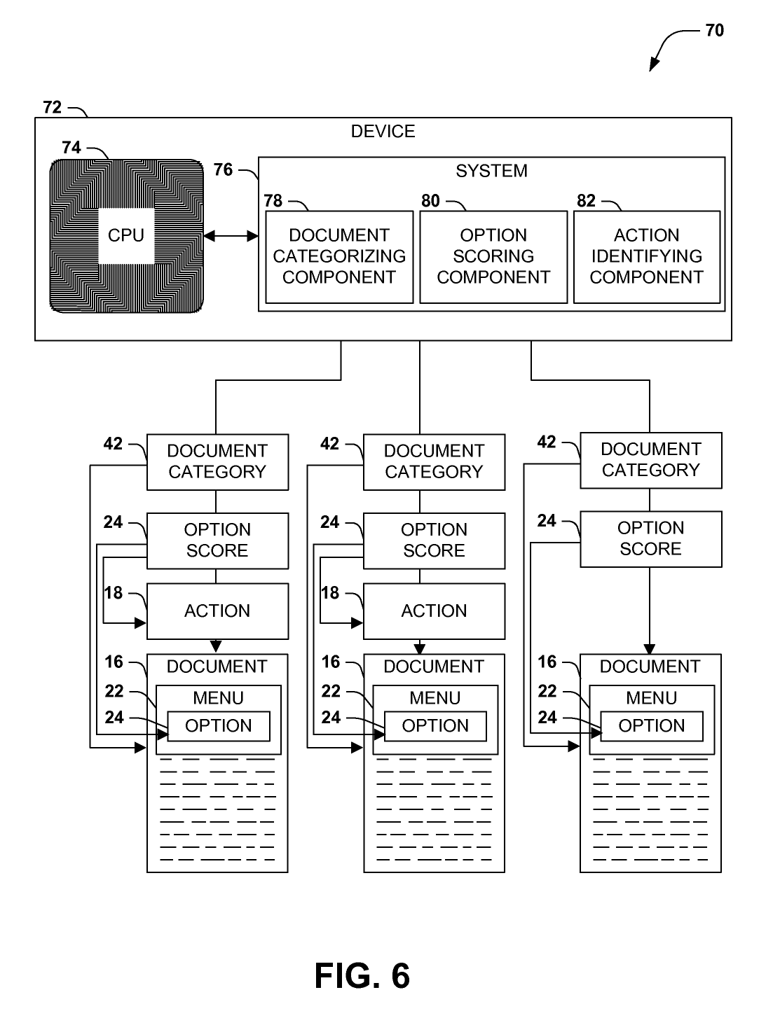

FIG. 6 presents a second embodiment of these techniques, illustrated in this exemplary scenario 70 as an exemplary system 76 configured to identify actions 18 available for at least one document 16. The exemplary system 76 may be implemented, e.g., as instructions stored in a memory of the device 72, and configured to implement various components of an architecture, such that, when the instructions are executed on a processor 74 of a device 72, interoperate to perform the techniques presented herein. In this exemplary scenario 70, the exemplary system 76 comprises a document categorizing component 78, which is configured to, for respective documents 16, identify a document category 42 of the document 716. The exemplary system 76 also comprises an option scoring component 80, which is configured to, for respective documents 16, identify at least one menu 22 of the document 16; for respective menus 22 of the document 16, identify at least one option 24 of the menu 22; and for respective options 24 of the menus 22 of the document 16, assign an option score 44 to the option 24. The exemplary system 74 also comprises an action identifying component 82, which is configured to, for respective document categories 42, identify as actions 18 the options 24 having high option scores 44 among the documents 16 of the document category 42. In this manner, the components of the exemplary system 74 interoperate to identify actions 18 associated with various documents 16, based on the options 24 of the menus 22 of the document 16 and the options 24 that arise frequently among the documents 16 within a document category 42.

Still another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

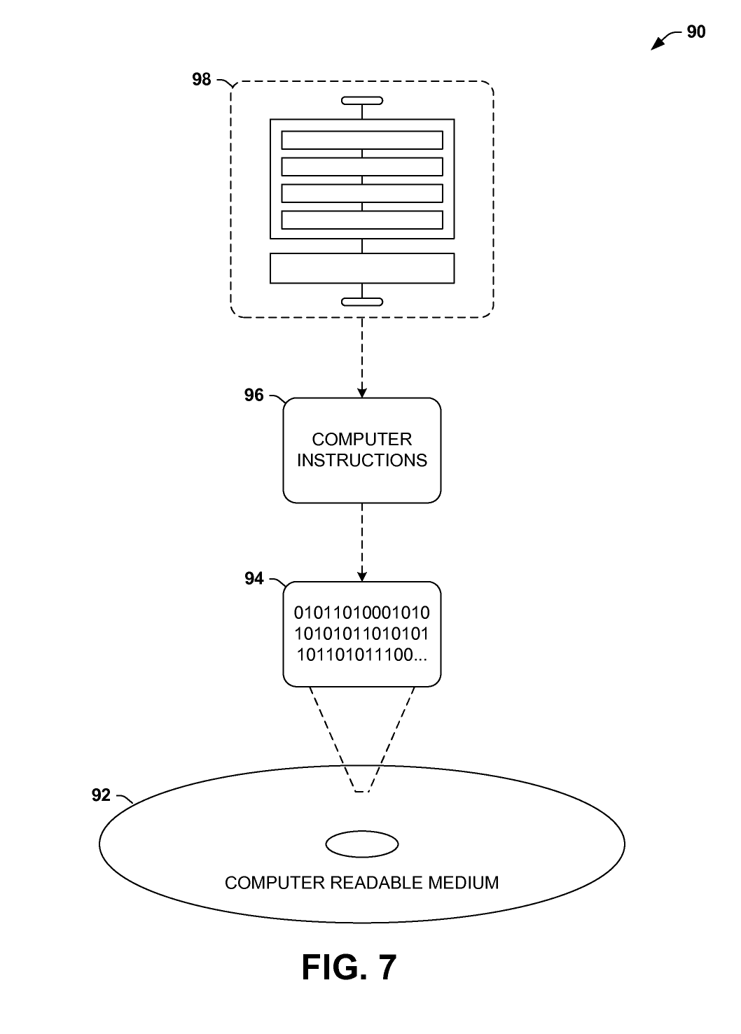

FIG. 7 illustrates an exemplary scenario 90 featuring an embodiment of these techniques as an exemplary computer-readable storage medium 92 (e.g., a CD-R, DVD-R, or a platter of a hard disk drive) on which is encoded computer-readable data 94. This computer-readable data 94 in turn comprises a set of computer instructions 96 configured to operate according to the principles set forth herein. In one such embodiment, the processor-executable instructions 96 may be configured to perform a method of identifying actions available for various documents, such as the exemplary method 50 of FIG. 5. In another such embodiment, the processor-executable instructions 96 may be configured to implement a system for identifying actions available for various documents, such as the exemplary system 76 of FIG. 6. Some embodiments of this computer-readable medium may comprise a nontransitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 50 of FIG. 5 and the exemplary system 76 of FIG. 6) to confer individual and/or synergistic advantages upon such embodiments.

A first aspect that may vary among embodiments of these techniques relates to the scenarios wherein these techniques may be utilized. As a first example, these techniques may be used to identify actions 18 associated with many types of documents 16, such as web pages of websites, Portable Document Format (PDF) objects, or Rich Text Format (RTF) objects. Such documents 16 may also represent many topics, such as individuals, locations, events, information sets, or physical objects. As a second example of this first aspect, many types of menus 22 and options 24 may be identified within such documents 16, including navigation bars embedded in websites using various mechanisms (e.g., an image having areas corresponding to different options 24 associated with hyperlinks or action scripts; an HTML layout component, such as a DIV, FRAME, or TABLE, having elements corresponding to options 24; an array of buttons; a menu bar disposed within an application rendering the document 16; or a table of contents in a document 16). As a third example of this first aspect, many types of document categories 42 may be identified for respective documents 16; such as documents 16 associated with a particular topic (e.g., a particular location) or a set of similar topics (e.g., a set of similar locations); documents created by the same author or a set of similar authors; documents available from a particular source or from a set of similar sources; documents having a particular document format (e.g., HTML-formatted web pages respectively published by a website associated with a website category); or documents having a similar document type (e.g., a biography of an individual, a blueprint of a location, a database for an information set, or a human-readable reference manual). Those of ordinary skill of the art may devise many scenarios wherein the techniques presented herein may be utilized.

A second aspect that may vary among embodiments of these techniques relates to the manner of identifying the document categories 42 of the documents 16. As a first example, the documents 16 may self-identify a document category 42. For example, a document 16 comprising a web page may include a META-type HTML tag that include a keyword identifying a topic associated with the web page. A document category 42 may therefore be selected for the web page based on the META keyword.

As a second example of this second aspect, while a document 16 may not self-identify a document category 42, a document category 42 may be identified by metadata associated with the document 16, such as the source, format, or type of the document 16. As one such example, the document 16 may comprise a website referenced by a website directory, which may be configured to, for a particular website category, present links to websites within the website category (e.g., a website directory of websites for restaurants in various cities and of various types of cuisine). An embodiment of these techniques may therefore be configured to identify a document category 42 of respective documents 16 by identifying the website category associated with the website in the website directory.

As a third example of this second aspect, the documents 16 may not include information that may directly identify the document category 42, but automated techniques may be applied to infer the document category 42 of a document 16. In one such scenario, the documents 42 may comprise web pages respectively published by a website. An embodiment may be configured to retrieve the web pages of the respective websites, e.g., by, for respective web pages of a website, identifying links to linked web pages within the website, and retrieving the linked web pages of the website. However, while the website may be semantically associated with a website category, the web pages might not directly indicate the website category. In such scenarios, the documents 16 may be categorized by utilizing a document classifier that is configured to identify document categories 42 of respective documents 16. For example, a document classifier may be generated using machine learning techniques, e.g., by generating a training set comprising documents 16 that are known to be associated with particular document categories 42, and training an artificial neural network or Bayesian classifier to identify properties of the documents 16 associated with the respective document categories 42. Once trained, the document classifier may be invoked to identify the document category 42 of a document 16 in furtherance of the techniques presented herein. Those of ordinary skill in the art may devise many ways of identifying the document categories 42 of various documents 16 while implementing the techniques presented herein.

A third aspect that may vary among embodiments of these techniques relates to the manner of assigning an option score 44 to an option 24 in order to indicate the likelihood that the option 24 is associated with an action 18. Many factors may be taken into account when assigning this score. As a first example, the option score 44 may be assigned based on a resource or destination targeted by the option 24. For example, an option 24 linking from a movie theater website to an e-commerce site is likely to be associated with an action 18 such as ordering tickets, and an option 24 linking from the movie theater website to a movie database is likely to be associated with an action 18 such as viewing a description of a movie. By contrast, an option 24 linking from the movie theater website to another part of the same website may be more likely to involve a navigational option than an action 18.

As a second example of this third aspect, the degree of similarity in a phrase representing the option 24 and a phrase representing the action 18 may be assessed. For example, for an action 18 associated with the phrase “Buy Tickets,” options 24 associated with phrases such as “buy tickets,” “purchase tickets,” and “buy a ticket” may be assigned high option scores 44, while options 24 associated with phrases such as “buy passes,” “get tickets,” and “order a ticket” may be assigned somewhat lower option scores 44.

As a third example of this third aspect, various aspects of the phrase associated with the option 24 may be evaluated, such as a part-of-speech feature (e.g., a phrase based on a verb or dictionary noun may be more likely to be associated with an action 18 than a phrase based on a proper noun or an unrecognized term) and/or a statistical feature (e.g., a phrase beginning with an uppercase character may be more indicative of an action 18 than a phrase beginning with a lowercase character or a number). Accordingly, an embodiment of these techniques may assign an option score 44 to an option 24 by identifying a part-of-speech feature of the option and at least one statistical feature, computing a part-of-speech feature score based on the part-of-speech feature and a statistical feature score based on the statistical feature, and then assigning the option score 44 based (in whole or in part) on the part-of-speech feature score and the statistical feature score.

As a fourth example of this third aspect, an option score 18 may be assigned to an option 24 based on the context of the menu 22 containing the option 24, and on the context of the document 16 containing the menu 22. It may be appreciated that an option 24 is more likely to be associated with an action 18 if the other options 24 of the menu 22 are highly associated with actions 18, which may suggest that the menu 22 is intended to present a set of actions. Additionally, it may be appreciated that a menu 22 is more likely to include options 24 associated with actions 18 if it is among other menus 22 of the document 16 that are associated with actions 18, which may suggest that the document 16 presents sets of actions 18 within a set of menus 22. Accordingly, a reflexive process may be utilized, such as by first assigning option scores 44 to options 24 of the document 16; assigning menu scores to respective menus 22 of the document 16 based on the option scores 24 of the options 24 within the menu 22; and assigning a document score to the document 16 based on the menus scores of the menus 22 within the document 16. When these scores are assigned, the option scores 44 of the options 24 may be updated based on the document score and/or menu score of the document 16 and menu 22, respectively, that contain the option 24.

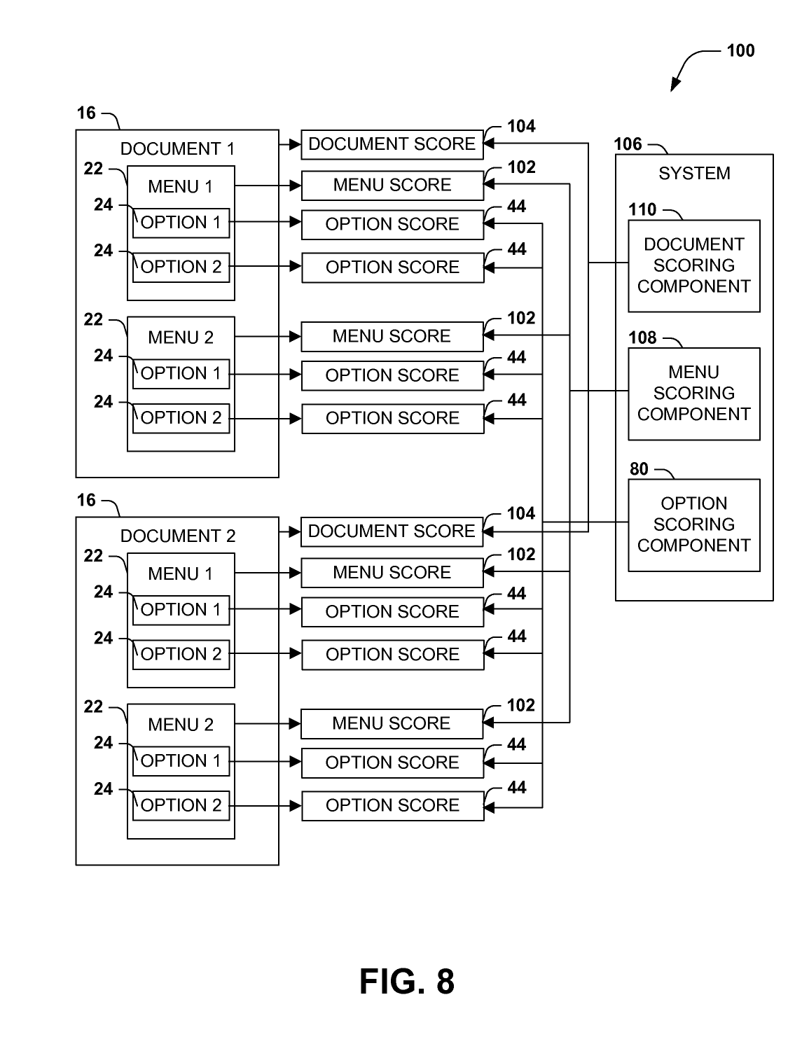

FIG. 8 presents an exemplary scenario 100 featuring an exemplary system 106 configured to assign scores to options 24, menus 22, and documents 16. In this exemplary scenario 100, two documents 16 are presented, each featuring two menus 22 that each features two options 24. In accordance with this fourth example of this third aspect, the assignment of option scores 44 to options 24 may take into account the scores assigned to menus 22 and/or documents 16. For example, an option scoring component 80 of the exemplary system 106 may initially assign an option score 44 to each option 24 (e.g., based on the part-of-speech feature and/or statistical feature of a phrase associated with the option 24 and/or a resource or target linked to the option 24). A menu scoring component 108 of the exemplary system 106 may be invoked to assign menu scores 102 to the menus 22 based on the option scores 44 of the options 24; and a document scoring component 110 of the exemplary system 106 may be invoked to assign document scores 104 to the documents 16 based on the menu scores 104 of the menus 22. Additionally, the option scoring component 80 may then adjust the option scores 44 of the options 24 based on the menu scores 102 and/or the document scores 104, thereby promoting an assignment of accurate option scores 44 based on the context of an option 24 within a particular menu 22 and/or document 16.

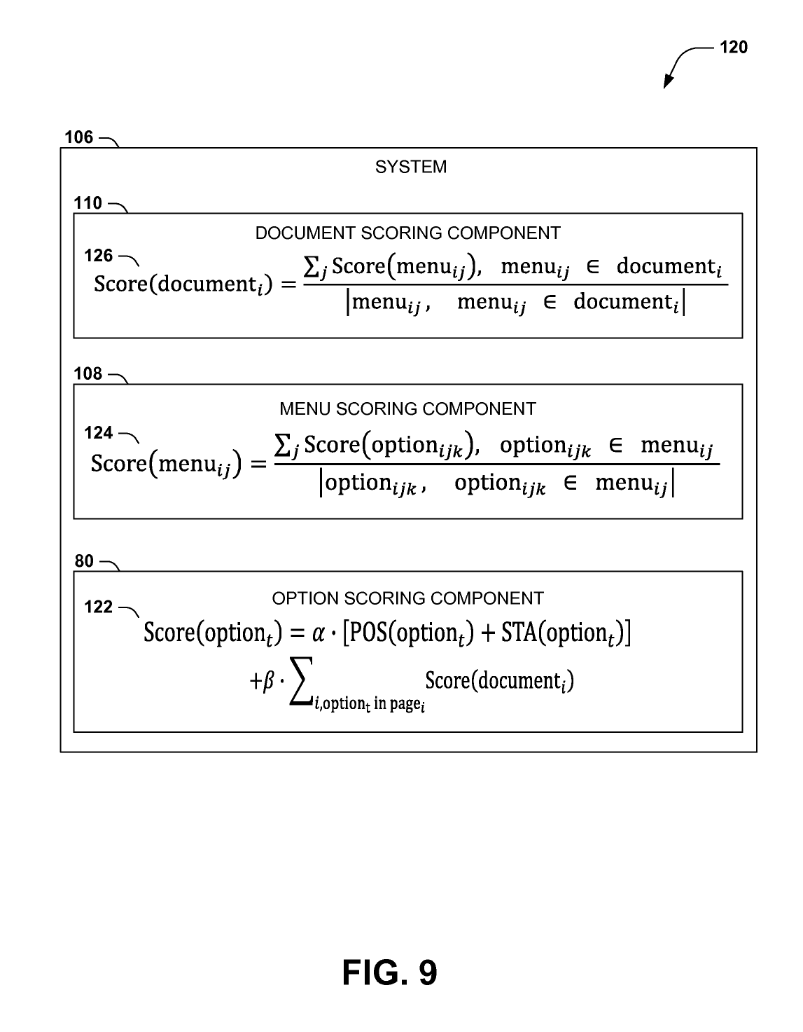

In furtherance of this fourth example of this third aspect, FIG. 9 presents a set of formulae 120 that may used to compute option scores 44, menu scores 102, and/or document scores 104 (e.g., by implementation, respectively, within an option scoring component 80, a menu scoring component 108, and a document scoring component 110 of an exemplary system 106). It may be appreciated that these mathematical formulae are submitted only as one set of examples, and that many variations in the design, implementation, and/or use of such mathematical formulae may be incorporated into an embodiment of these techniques.

First, an option score formula 122 may be utilized to compute option scores 44 for respective options 24 according to the mathematical formula:

Score(optionₜ)=α·[POS(optionₜ)+STA(optionₜ)]+β·Σ_{i,option}_{ₜ}_{in page}_{ᵢ} Score(documentᵢ)

wherein:
optionₜ comprises an option t in a menu of page i;
α comprises a first mathematical weight constant;
POS(optionₜ) comprises a part-of-speech feature score assigned to the option 44;
STA(optionₜ) comprises a statistical feature score assigned to the option 44;
β comprises a second mathematical weight constant; and
Score(documentᵢ) comprises a score assigned to document i.

(For example, α and β may be used to compute the relative contribution to the option score 44, respectively, of intrinsic traits of an option 24, such as the part-of-speech feature and statistical features, and extrinsic traits of the option 24, such as the contribution of the document score 104).

Second, a menu score formula 124 may be utilized to compute a menu score 102 for respective menus 22, based on the computation of option scores 44, according to the mathematical formula:

$$Score ( {menu}_{ij} ) = \frac{{Σ}_{j} Score ( {option}_{ijk} ) , {option}_{ijk} ∈ {menu}_{ij}}{\vert {option}_{ijk} , {option}_{ijk} ∈ {menu}_{ij} \vert}$$

wherein:

menuᵢⱼ comprises a menu j in a document i;

optionᵢⱼₖ comprises an option k of the menu j in the document i; and

Score(optionᵢⱼₖ) comprises an option score assigned to option k.

Third, a document score formula 126 may be utilized to compute a document score 104 for respective documents 16, based on the computation of menu scores 102, according to the mathematical formula:

$$Score ( {document}_{i} ) = \frac{{Σ}_{j} Score ( {menu}_{ij} ) , {menu}_{ij} ∈ {document}_{i}}{\vert {menu}_{ij} , {menu}_{ij} ∈ {document}_{i} \vert}$$

wherein:

menuᵢⱼ comprises a menu j in a document i; and

Score(menuᵢⱼ) comprises a menu score assigned to menu j.

In a further embodiment, this reflexive process may continue as a set of iterations until a stable set of scores are achieved. For example, an initial option score, and initial menu score, and an initial document score may be assigned respectively to each option 24, menu 22, and document 16; and these scores may be iteratively updated until an iteration criterion is satisfied (e.g., until the magnitude of changes in the scores for an iteration are sufficiently low to suggest stability).

As a fifth example of this third aspect, additional techniques may be applied to adjust and/or improve the assignment of option scores 44. As one such example, option scores 44 for various options 24 may be improved by techniques for clustering options 24, menus 22, and/or documents 16 based on various similarities detected thereamong. For example, documents 16 that seem to be similar (e.g., associated with a similar topic or written by the same author) may be clustered, and options 24 included in documents 16 within a cluster may be more highly associated with the same action 18. Moreover, if the options 24 are included in menus 22 that appear to be similar within a cluster of documents 16, the option scores 44 of the options 24 may be additionally clustered.

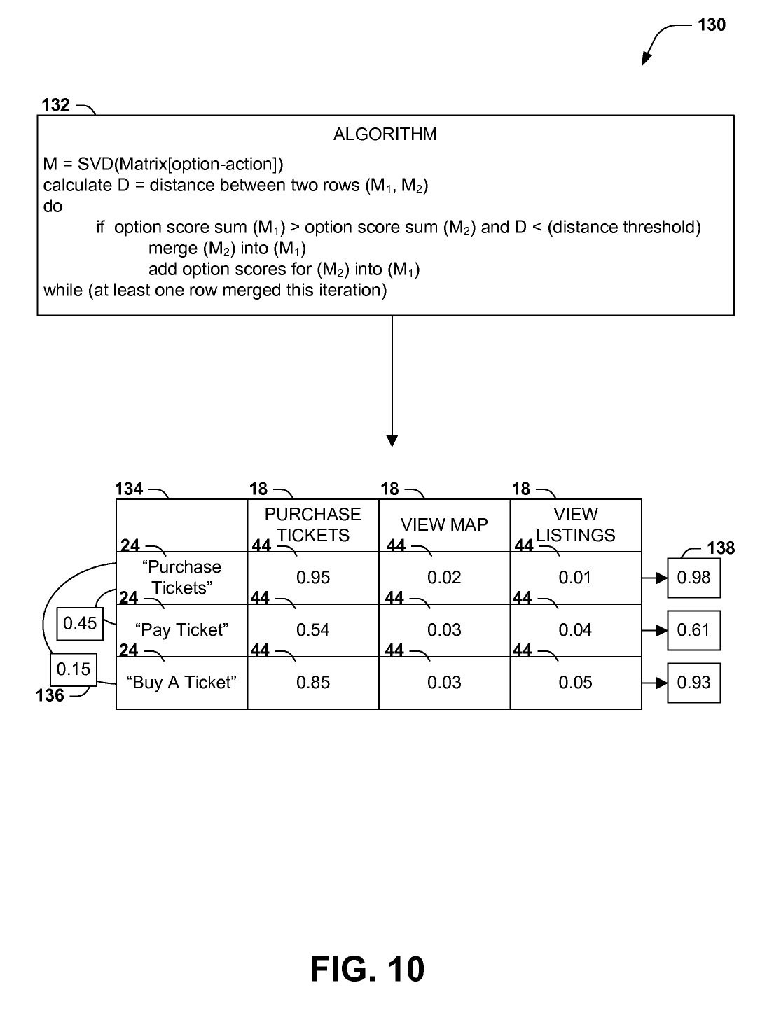

FIG. 10 presents an exemplary scenario 130 featuring a clustering of options 24 according to an exemplary algorithm 132. It may be appreciated that this algorithm 132 may be implemented in many ways (e.g., in various imperative and/or declarative programming languages, and as a partially or wholly compiled binary or as an interpreted script), and that the exemplary algorithm 132 is only one of many such algorithms may be implemented in order to generate and utilize the clustering provided in this fifth example of this third aspect. In accordance with this exemplary algorithm 132, once option scores 44 are assigned to various options 24, a matrix 134 may be generated that assigns an option score 44 to each option 24 for each action 18 with which the option 24 may be associated. For example, in a set of documents 16, a set of options 24 identified by the phrases “Purchase Tickets,” “Pay Ticket,” and “Buy A Ticket” may be identified. Each option 24 may be compared with a set of actions 18 with which the option 24 may be associated (e.g., purchasing a ticket for a movie at a movie theater, viewing a map, and viewing movie listings). For example, the options 24 associated with the phrases “Purchase Tickets” and “Buy A Ticket” may each have high option scores 44 for the “Purchase Tickets” action 18, but the phrase “Pay Ticket” may be more ambiguous (e.g., involving paying for a traffic ticket), and may have a lower option score 44. However, all of these options 24 may all have comparatively low option scores 44 for the other actions 18. Additionally, an option score sum 138 for may be computed for each option 24, and a first option 24 having a lower option score sum 138 may be merged into a second option 138 having a higher option score sum 138.

Within this exemplary scenario 130, and in accordance with this exemplary algorithm 132, the matrix 134 may be adjusted to cluster the options 24 for particular actions 18. For example, each option 24 (as a row) may be compared with the other options 24, such as by comparing an option score difference 136 comprising the sum of the differences of the option scores 44 for two rows. If the option scores 44 of two options 24 are discovered to be very similar, the option 24 having the lower option score sum 138 may be merged into the option 24 having the higher option score sum 138. For example, the option 24 involving the phrase “Buy a Ticket” may be found to have very similar scores to the option 24 involving the phrase “Purchase Tickets,” as indicated by a comparatively low option score difference 136 (as compared with the higher option score difference 136 comparing this same option 24 with the option 24 associated with the phrase “Pay Ticket”). If the option score difference 136 is below a particular threshold of similarity (e.g., if the options 24 have similar option scores), the option 24 for the first row having the lower option score sum 138 may be merged into the option 24 for the second row having the higher option score sum 138. In this manner, lower-scoring options 24 may be merged into similar but higher-scoring options 24, thereby clustering the options 24 associated with a particular action 18. Those of ordinary skill in the art may devise many techniques for calculating option scores 44 for options 24 in accordance with the techniques presented herein.

A fourth aspect that may vary among embodiments of these techniques relates to uses of these techniques. In some such embodiments, after identifying various actions 18 that may be available for a document 16, the actions 18 may be presented to a user 12. As a first example, a user 12 may request an identification of documents 16 that support a particular action 18, e.g., websites that provide an action 18 involving an online purchase of tickets to a movie. An embodiment of these techniques may fulfill this request by identifying documents 16 including at least one option 24 of a menu 22 that is associated with the action 18, and presenting such identified documents 16 to the user 12. Conversely, as a second example, a user 12 may request an identification of actions 18 that are supported by a particular document 16. An embodiment of these techniques may fulfill this request by identifying the actions 18 associated with the options 24 of the menus 22 of the document 16, and by presenting such identified actions 24 to the user 12. Alternatively or additionally, an embodiment of these embodiments may permit the user 12 to request to invoke an action 18 in a document 16, and may fulfill this request by identifying an option 24 of a menu 22 of the document 16 that is associated with the action 18, and by invoking the option 24 on behalf of the user 12. For example, if an action 18 requested by a user 12 is associated with an option 24 of a menu 22 of a website, and if the option 24 comprises a hyperlink to a web page (within or outside of the website), an embodiment of these techniques may, upon receiving a request from the user 12 to perform the action 18, retrieve the web page of the website associated with the option 24, and present the web page to the user 12. Those of ordinary skill in the art may devise many such uses of the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

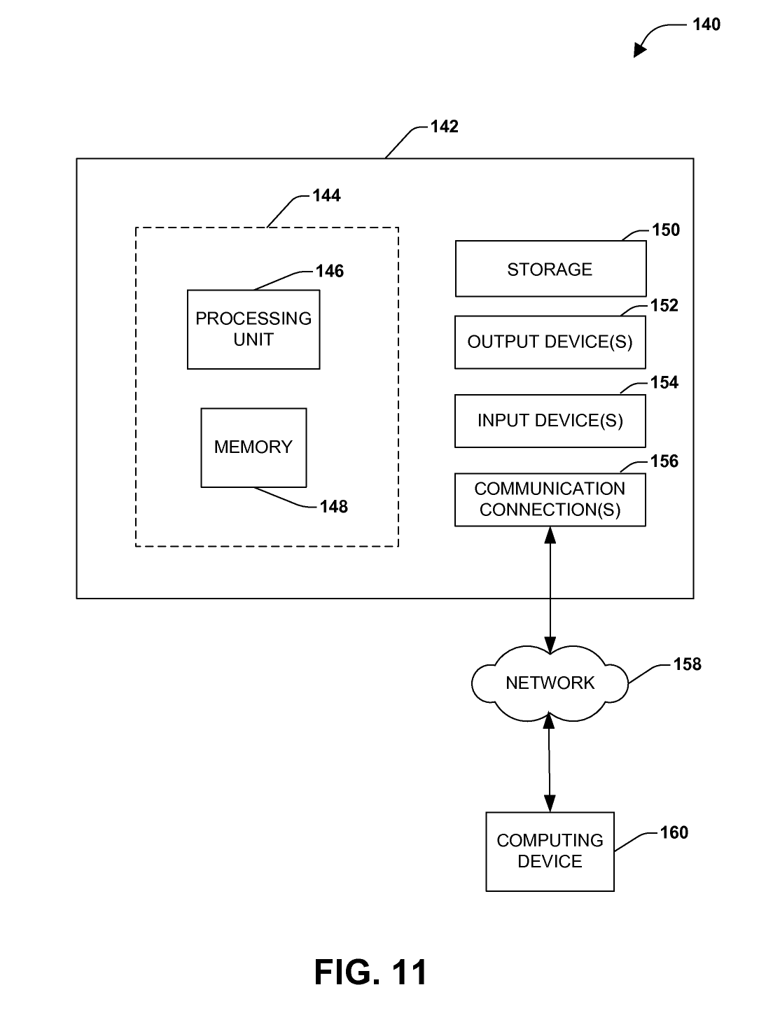

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 140 comprising a computing device 142 configured to implement one or more embodiments provided herein. In one configuration, computing device 142 includes at least one processing unit 146 and memory 148. Depending on the exact configuration and type of computing device, memory 148 may be volatile (such as RAM, for example), non-volatile (such as ROM, flash memory, etc., for example) or some combination of the two. This configuration is illustrated in FIG. 11 by dashed line 144.

In other embodiments, device 142 may include additional features and/or functionality. For example, device 142 may also include additional storage (e.g., removable and/or non-removable) including, but not limited to, magnetic storage, optical storage, and the like. Such additional storage is illustrated in FIG. 11 by storage 150. In one embodiment, computer readable instructions to implement one or more embodiments provided herein may be in storage 150. Storage 150 may also store other computer readable instructions to implement an operating system, an application program, and the like. Computer readable instructions may be loaded in memory 148 for execution by processing unit 146, for example.

The term “computer readable media” as used herein includes computer storage media. Computer storage media includes volatile and nonvolatile, removable and non-removable media implemented in any method or technology for storage of information such as computer readable instructions or other data. Memory 148 and storage 150 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 142. Any such computer storage media may be part of device 142.

Device 142 may also include communication connection(s) 156 that allows device 142 to communicate with other devices. Communication connection(s) 156 may include, but is not limited to, a modem, a Network Interface Card (NIC), an integrated network interface, a radio frequency transmitter/receiver, an infrared port, a USB connection, or other interfaces for connecting computing device 142 to other computing devices. Communication connection(s) 156 may include a wired connection or a wireless connection. Communication connection(s) 156 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 142 may include input device(s) 154 such as keyboard, mouse, pen, voice input device, touch input device, infrared cameras, video input devices, and/or any other input device. Output device(s) 152 such as one or more displays, speakers, printers, and/or any other output device may also be included in device 142. Input device(s) 154 and output device(s) 152 may be connected to device 142 via a wired connection, wireless connection, or any combination thereof. In one embodiment, an input device or an output device from another computing device may be used as input device(s) 154 or output device(s) 152 for computing device 142.

Components of computing device 142 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 142 may be interconnected by a network. For example, memory 148 may be comprised of multiple physical memory units located in different physical locations interconnected by a network.

Those skilled in the art will realize that storage devices utilized to store computer readable instructions may be distributed across a network. For example, a computing device 160 accessible via network 158 may store computer readable instructions to implement one or more embodiments provided herein. Computing device 142 may access computing device 160 and download a part or all of the computer readable instructions for execution. Alternatively, computing device 142 may download pieces of the computer readable instructions, as needed, or some instructions may be executed at computing device 142 and some at computing device 160.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of identifying actions available for at least one document on a device having a processor, the method comprising:
executing on the processor instructions configured to:
for respective documents:
identify a document category of the document;
identify at least one menu in the document;
for respective menus, identify at least one option; and
for respective options, assign an option score to the option; and
for respective document categories, identify as actions the options having high option scores among the documents of the document category.

2. The method of claim 1:
the device having a document classifier configured to identify document categories of respective documents; and
identifying the document category of a document comprising: invoking the document classifier to identify the document category of the document.

3. The method of claim 1, the documents comprising web pages respectively published by a website associated with a website category.

4. The method of claim 3, the instructions configured to:
retrieve web pages from respective websites; and
for respective web pages of a website:
identify links to linked web pages within the website, and
retrieve the linked web pages of the website.

5. The method of claim 3:
the device having access to a website directory identifying website categories for respective website; and
identifying a website category of a website comprising: identifying the website category associated with the website in the website directory.

6. The method of claim 1, assigning an option score to an option comprising:
identifying a part-of-speech feature of the option;
identifying at least one statistical feature of the option; and
assigning an option score to the option based on a part-of-speech feature score based on the part-of-speech feature and a statistical feature score based on the statistical feature.

7. The method of claim 6, assigning an option score to an option comprising:
assigning an option score to the option;
assigning a menu score to menu based on the option scores of the options of the menu;
assigning a document score to the document based on the menu scores of the menus of the document; and
updating the option score based on the document score of the document containing the option.

8. The method of claim 7, assigning an option score to an option comprising:
assigning an initial option score to the option;
assigning an initial menu score to the menu;
assigning an initial document score to the document score; and
until satisfying an iteration criterion, iteratively updating the option scores of the options, the menu scores of the menus, and the document scores of the documents.

9. The method of claim 8, assigning an option score comprising:
assigning the option score according to a mathematical formula comprising:
Score(optionₜ)=α·[POS(optionₜ)+STA(optionₜ)]+β·Σ_{i,option}_{ₜ}_{in page}_{ᵢ} Score(documentᵢ)
wherein:
optionₜ comprises an option t in a menu of page i;
α comprises a first mathematical weight constant;
POS(optionₜ) comprises a part-of-speech feature score assigned to the option;
STA(optionₜ) comprises a statistical feature score assigned to the option;
β comprises a second mathematical weight constant; and
Score(documentᵢ) comprises a score assigned to document i.

10. The method of claim 8, assigning a menu score comprising: assigning the menu score according to a mathematical formula comprising:
$$Score ( {menu}_{ij} ) = \frac{{Σ}_{j} Score ( {option}_{ijk} ) , {option}_{ijk} ∈ {menu}_{ij}}{\vert {option}_{ijk} , {option}_{ijk} ∈ {menu}_{ij} \vert}$$
wherein:
menuᵢⱼ comprises a menu j in a document i;
optionᵢⱼₖ comprises an option k of the menu j in the document i; and
Score(optionᵢⱼₖ) comprises an option score assigned to option k.

11. The method of claim 8, assigning a document score comprising: assigning the document score according to a mathematical formula comprising:
$$Score ( {document}_{i} ) = \frac{{Σ}_{j} Score ( {menu}_{ij} ) , {menu}_{ij} ∈ {document}_{i}}{\vert {menu}_{ij} , {menu}_{ij} ∈ {document}_{i} \vert}$$
wherein:
menuᵢⱼ comprises a menu j in a document i; and
Score(menuᵢⱼ) comprises a menu score assigned to menu j.

12. The method of claim 1, comprising: after assigning option scores to respective options, clustering at least two options within a document category associated with an action.

13. The method of claim 12, clustering the options comprising:
identifying two options matching an action;
between the two options, identifying a first option having a higher option score sum and a second option having a lower option score sum; and
merging the second option into the first option.

14. The method of claim 13, clustering the options comprising:
generating a matrix correlating options with actions;
for respective first rows of the matrix:
comparing the option scores of the first row with the option scores of other rows of the matrix; and
upon identifying a second row of the matrix having similar option scores to the first row and having a higher option score sum than the option score sum of the first row, merging the first row into the second row.

15. The method of claim 1, the instructions configured to, upon receiving a request from a user to identify at least one document within a document category associated with an action:
identify the documents of the document category having at least one option of at least one menu associated with the action, and
present the documents to the user.

16. The method of claim 1, the instructions configured to, upon receiving a request from a user to identify actions associated with a document:
identify the actions associated with at least one option of at least one menu of the document, and
present the actions to the user.

17. The method of claim 1, the instructions configured to, upon receiving a request from a user to perform an action associated with a document,
identify the option associated with the action in the document, and
invoke the option on behalf of the user.

18. The method of claim 17:
the documents comprising web pages respectively published by a website; and
invoking the action to the user comprising:
retrieving a web page of the website associated with the action, and
presenting the web page to the user.

19. A system configured to identify actions available for at least one document on a device having a processor, the system comprising:
a document categorizing component configured to, for respective documents, identify a document category of the document;
an option scoring component configured to, for respective documents:
identify at least one menu in the document;
for respective menus, identify at least one option; and
for respective options, assign an option score to the option; and
an action identifying component configured to, for respective document categories, identify as actions the options having high option scores among the documents of the document category.

20. A computer-readable storage medium comprising instructions that, when executed on a processor of a device having a document classifier configured to identify document categories of respective documents, identify actions available for at least one document a comprising web page respectively published by a website and associated with a website category by:
retrieving web pages from respective websites by, for respective web pages of a website:
identifying links to linked web pages within the website, and
retrieving the linked web pages of the website;
for respective documents:
invoking the document classifier to identify the document category of the document to identify a document category of the document;
identifying at least one menu in the document;
for respective menus, identifying at least one option; and
for respective options, assigning an option score to the option by:
identifying a part-of-speech feature of the option;
identifying at least one statistical feature of the option;
assigning an initial option score to the option based on a part-of-speech feature score based on the part-of-speech feature and a statistical feature score based on the statistical feature;
assigning an initial menu score to the menu;
assigning an initial document score to the document score; and
until satisfying an iteration criterion:
iteratively updating the option scores of the options based on the document score of the document containing the option according to a mathematical formula comprising:
Score(optionₜ)=α·[POS(optionₜ)+STA(optionₜ)]+β·Σ_{i,option}_{ₜ}_{in page}_{ᵢ} Score(documentᵢ)
wherein:
optionₜ comprises an option t in a menu of page i;
α comprises a first mathematical weight constant;
POS(optionₜ) comprises a part-of-speech feature score assigned to the option;
STA(optionₜ) comprises a statistical feature score assigned to the option;
β comprises a second mathematical weight constant; and
Score(documentᵢ) comprises a score assigned to document i;
iteratively updating the menu scores of the menus based on the option scores of the options of the menu according to a mathematical formula comprising:
$$Score ( {menu}_{ij} ) = \frac{{Σ}_{j} Score ( {option}_{ijk} ) , {option}_{ijk} ∈ {menu}_{ij}}{\vert {option}_{ijk} , {option}_{ijk} ∈ {menu}_{ij} \vert}$$
wherein:
menuᵢⱼ comprises a menu j in a document i;
optionᵢⱼₖ comprises an option k of the menu j in the document i; and
Score(optionᵢⱼₖ) comprises an option score assigned to option k; and
iteratively updating the document scores of the documents based on the menu scores of the menus of the document according to a mathematical formula comprising:
$$Score ( {document}_{i} ) = \frac{{Σ}_{j} Score ( {menu}_{ij} ) , {menu}_{ij} ∈ {document}_{i}}{\vert {menu}_{ij} , {menu}_{ij} ∈ {document}_{i} \vert}$$
wherein:
menuᵢⱼ comprises a menu j in a document i; and
Score(menuᵢⱼ) comprises a menu score assigned to menu j;
for respective document categories, identifying as actions the options having high option scores among the documents of the document category;
clustering at least two options within a document category associated with an action by:
generating a matrix correlating options with actions;
for respective first rows of the matrix:
comparing the option scores of the first row with the option scores of other rows of the matrix; and
upon identifying a second row of the matrix having similar option scores to the first row and having a higher option score sum than an option score sum of the first row, merging the first row into the second row;
upon receiving a request from a user to identify at least one document within a document category associated with an action:
identifying the documents of the document category having at least one option of at least one menu associated with the action, and
presenting the documents to the user;
upon receiving a request from a user to identify actions associated with a document:
identifying the actions associated with at least one option of at least one menu of the document, and
presenting the actions to the user; and
upon receiving a request from a user to perform an action associated with a document:
identifying an action associated with the web page;
retrieving a web page of the website associated with the action, and
presenting the web page to the user.
